(19) United States
(12) Patent Application Publication
(10) Pub. No.: US 2026/0360036 A1
(43) Pub. Date: Nov. 12, 2026

(54) FEW-STEP SWIFTBRUSH TEXT-TO-IMAGE MODEL

(71) Applicant: QUALCOMM Incorporated, San Diego, CA (US)

(72) Inventors: Bao Quoc Tran, Hà Nôi (VN); Khoi Duc Minh Nguyen, Hô Chí Minh (VN); Anh Tuan Tran, Hà Nôi (VN); Hung Hai Bui, Hà Nôi (VN)

(21) Appl. No.: 19/339,982

(22) Filed: Sep. 25, 2025

Related U.S. Application Data
(60) Provisional application No. 63/803,252, filed on May 9, 2025.

(51) Int. Cl. G06T 11/60; G06T 11/10

(52) U.S. Cl. CPC G06T 11/60; G06T 11/10

(57) ABSTRACT

Devices, methods, and computer-readable media for image generation are described herein. An example device includes one or more memories and one or more processors coupled to the one or more memories. The one or more processors are configured to receive a prompt to generate an image. The one or more processors are configured to apply a few-step model based on the prompt to generate the image, wherein the few-step model is distilled from a one-step teacher model and at least one other teacher model.

This application claims the benefit of U.S. Provisional Application No. 63/803,252, filed May 9, 2025, the entire contents of which are hereby incorporated by reference.

### TECHNICAL FIELD

This disclosure relates to image generation.

### BACKGROUND

For artificial intelligence (AI) and/or machine learning (ML) (AI/ML) based image generation techniques, a user may provide textual input to a text-to-image model. The textual input may describe the subject of the desired image to be generated and/or include contextual information related to the desired image. The text-to-image model may generate the image based on the textual input.

### SUMMARY

This disclosure relates generally to techniques and devices for generating images using AI/ML (e.g., AI/ML generated images). Text-to-image models exist that convert textual input (e.g., a prompt) into an image. Text-to-image models may include so called multi-step text-to-image models, few-step text-to-image models, and one-step text-to-image models. A multi-step text-to-image model may generate an image from a textual input in a relatively large number of iterative steps or operations. A few-step text-to-image model may generate an image from a textual input in a relatively few iterative steps or operations. A one-step text-to-image model may generate an image from a textual input in a single step or operation.

Few-step and one-step text-to-image models are often obtained by distillation from multi-step models. One example of a one-step text-to-image model is SwiftBrush. SwiftBrush, which is distilled from a multi-step text-to-image teacher model, purportedly can produce quality images without image training data.

Multi-step text-to-image models take a relatively long time to generate images due to a large number of function evaluations (NFEs) (e.g., inferences) required to generate an image, thereby creating a potential latency issue. In other words, multiple-step text-to-image models are relatively slow. One-step text-to-image models (e.g., SwiftBrush) require only one NFE to generate an image. While one-step text-to-image models are significantly faster than multi-step text-to-image models, one-step text-to-image models may not be compatible with existing customization techniques that require a multi-step generation scheme (e.g., ControlNet, IP-Adapter). However, converting a one-step model to a multi-step model may lead to over-saturated outputs.

Few-step text-to-image models may require more than one NFE, but fewer NFEs than multi-step text-to-image models. Existing few-step distillation techniques, however, are not image-free (e.g., require image training data) and are computationally expensive, unlike SwiftBrush. Therefore, the existing few-step distillation techniques may be relatively inefficient.

The techniques of this disclosure include example few-step text-to-image distillation techniques, that may be at least partially based on a one-step text-to-image model, such as SwiftBrush. Such few-step text-to-image distillation techniques may result in a model that is relatively efficient and does not require images for training, building upon the SwiftBrush technique. Such a model of this disclosure may be relatively seamlessly integrated with existing customization techniques for diffusion models, such as editing, personalization, controlnet, etc. The few-step model may be moderately fast as the few-step model may require in the order of only 2-4 NFEs. 2-4 iterations may allow for editing or personalization. The few-step model may also have the capability to generate more aesthetically beautiful images with more NFEs, as compared to one-step model. In some examples, a one-step teacher model may be used, together with one or more multi-step teacher models, to generate the few-step model.

In one example, a device includes one or more memories; and one or more processors coupled to the one or more memories, the one or more processors configured to: receive a prompt to generate an image; and apply a few-step model based on the prompt to generate the image, wherein the few-step model is distilled from a one-step teacher model and at least one other teacher model.

In one example, a method includes receiving a prompt to generate an image; and applying a few-step model based on the prompt to generate the image, wherein the few-step model is distilled from a one-step teacher model and at least one other teacher model.

In one example, a non-transitory computer-readable media stores instructions, which when executed by one or more processors, cause the one or more processors to: receive a prompt to generate an image; and apply a few-step model based on the prompt to generate the image, wherein the few-step model is distilled from a one-step teacher model and at least one other teacher model.

The details of one or more examples of this disclosure are set forth in the accompanying drawings and the description below. Other features, objects, and advantages of various aspects of the techniques will be apparent from the description and drawings, and from the claims.

### BRIEF DESCRIPTION OF DRAWINGS

FIG. 1 is a block diagram illustrating an example of a device according to the techniques of this disclosure.

FIG. 2 is a flow diagram illustrating an example distillation technique.

FIG. 3 is a flow diagram illustrating yet another example distillation technique according to one or more aspects of this disclosure.

FIG. 4 is a flow diagram illustrating an example gradient flow of the distillation technique of FIG. 3 according to one or more aspects of this disclosure.

FIG. 5 is a chart illustrating scores of different models, including the few-step model of this disclosure.

FIG. 6 is a flow diagram illustrating example few-step text-to-image model technique according to one or more aspects of this disclosure.

### DETAILED DESCRIPTION

For AI/ML based image generation, a user provides a prompt, such as a textual input, that includes information indicative of subject(s) and/or context to generate in an image. Processing circuitry (e.g., one or more processors) may apply (e.g., execute) an AI/ML model, such as a neural network, that receives the textual input, generates an image based on the textual input, and outputs the image. The AI/ML model may be distilled and/or trained for generating such output images.

This disclosure describes example few-step text-to-image distillation techniques, that may be at least partially based on a one-step text-to-image model, such as SwiftBrush. Such few-step text-to-image distillation techniques may result in a model that is relatively efficient and trained image-free, building upon the SwiftBrush technique. Such a few-step model of this disclosure may be relatively seamlessly integrated with existing customization techniques for diffusion models, such as editing, personalization, controlnet, etc. The few-step model may be moderately fast as the model may require in the order of only 2-4 NFEs. The few-step model may also have the capability to generate more aesthetically beautiful images with more NFEs.

For purposes of illustration, the example techniques are described with respect to the subjects being human subjects. However, the example techniques are not so limited.

In the above examples, the input is a textual input. A textual input is one example, and input need not be limited to a typed textual input. For instance, the user may provide a spoken or recorded verbal input, rather than typing in the textual input and processing circuitry may convert the verbal input into text. Other examples of inputs are possible, and the disclosure should not be considered limited to typed textual inputs. In some examples, the input need not even be textual. For example, the input may be another image.

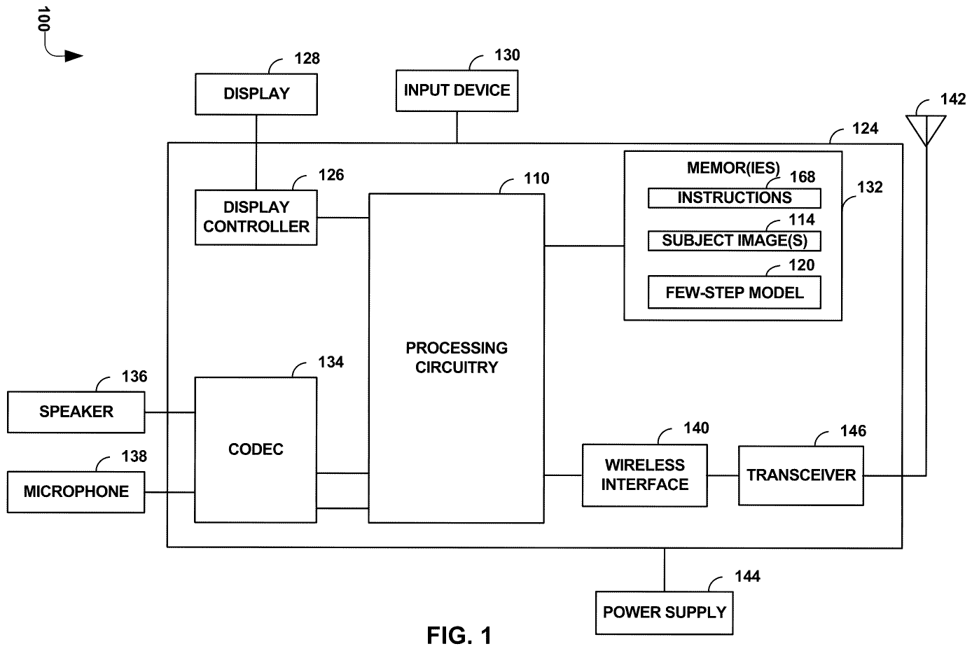

FIG. 1 is a block diagram illustrating an example of a device according to the techniques of this disclosure. In some examples, the device 100 may be a wireless communication device, such as a smartphone. In some examples, the device 100 may have more or fewer components than illustrated in FIG. 1. In an illustrative aspect, the device 100 may perform one or more operations described with reference to the techniques discussed in this disclosure.

In some examples, the device 100 includes processing circuitry 110 (e.g., one or more processors), such as central processing unit(s) (CPUs) and/or digital signal processor(s) (DSPs), coupled to one or more memories 132. The one or more memories 132 includes instructions 168 (e.g., executable instructions) such as computer-readable instructions or processor-readable instructions. The instructions 168 may include one or more instructions that are executable by a computer, such as the processing circuitry 110. The one or more memories 132 also include the few-step model 120.

As described in more detail, processing circuitry 110 may apply (e.g., execute) few-step model 120 to generate an image, e.g., of subject image(s) 114, based on received input (e.g., prompt). Few-step model 120 may include a few-step text-to-image model. Few-step model 120 may be based on a one-step teacher model, such as a SwiftBrush model.

Examples of few-step model 120 may include a diffusion model. In some examples, as described later in this disclosure, few-step model 120 is distilled based on a one-step teacher model and at least one multi-step teacher model (not shown in FIG. 1). Few-step model 120 may be configured to perform between 1 and 6 number of function evaluations (NFEs), inclusive, when generating the image, and in some examples, 2-4 NFEs.

The device 100 may include a display controller 126 that is coupled to the processing circuitry 110 and to a display 128. A coder/decoder (CODEC) 134 may also be coupled to the processing circuitry 110. A speaker 136 and a microphone 138 may be coupled to the CODEC 134.

FIG. 1 also illustrates that a wireless interface 140, such as a wireless controller, and a transceiver 146 may be coupled to the processing circuitry 110 and to an antenna 142, such that wireless data received via the antenna 142, the transceiver 146, and the wireless interface 140 may be provided to the processing circuitry 110. In some examples, the processing circuitry 110, the display controller 126, the one or more memories 132, the CODEC 134, the wireless interface 140, and the transceiver 146 are included in a system-in-package or system-on-chip device 124. In some examples, an input device 130 and a power supply 144 are coupled to the system-on-chip device 124. Moreover, in an example, as illustrated in FIG. 1, the display 128, the input device 130, the speaker 136, the microphone 138, the antenna 142, and the power supply 144 are external to the system-on-chip device 124. In some examples, each of the display 128, the input device 130, the speaker 136, the microphone 138, the antenna 142, and the power supply 144 may be coupled to a component of the system-on-chip device 124, such as an interface or a controller.

In some examples, the one or more memories 132 includes or stores the instructions 168 (e.g., executable instructions), such as computer-readable instructions or processor-readable instructions. For example, the one or more memories 132 may include or correspond to a non-transitory, computer readable medium storing the instructions 168. The instructions 168 may include one or more instructions that are executable by a computer, such as the processing circuitry 110. In some examples, the device 100 includes a non-transitory, computer readable medium (e.g., the one or more memories 132) storing instructions (e.g., the instructions 168) that, when executed by one more processors (e.g., the processing circuitry 110), may cause the one or more processors to perform operations described in this disclosure.

Various functions performed by the one or more components of the systems are described with reference to certain components or circuitry. This division of components and circuitry is for illustration only. In an alternate aspect, a function performed by a particular component may be divided amongst multiple components. Moreover, in an alternate aspect, two or more components described with reference to FIG. 1 may be integrated into a single component. Each component described with reference to FIG. 1 may be implemented using hardware (e.g., a field-programmable gate array (FPGA) device, an application-specific integrated circuit (ASIC), a DSP, a controller, etc.), software (e.g., instructions executable by a processor), or any combination thereof.

One or more of the disclosed aspects may be implemented in a system or an apparatus, such as the device 100, that may include a communications device, a fixed location data unit, a mobile location data unit, a mobile phone, a cellular phone, a satellite phone, a computer, a tablet, a portable computer, a display device, a media player, or a desktop computer. Alternatively or additionally, the device 100 may include a set top box, an entertainment unit, a navigation device, a personal digital assistant (PDA), a monitor, a computer monitor, a television, a tuner, a radio, a satellite radio, a music player, a digital music player, a portable music player, a video player, a digital video player, a digital video disc (DVD) player, a portable digital video player, a satellite, a vehicle, a component integrated within a vehicle, any other device that includes a processor or that stores or retrieves data or computer instructions, or a combination thereof. As another illustrative, non-limiting example, the device 100 may include remote units, such as hand-held personal communication systems (PCS) units, portable data units such as global positioning system (GPS) enabled devices, meter reading equipment, or any other device that includes a processor or that stores or retrieves data or computer instructions, or any combination thereof.

In accordance with one or more examples, processing circuitry 110 may receive a prompt to generate an image. Processing circuitry 110 may also apply few-step model 120 based on the prompt to generate the image. In some examples, few-step model 120 is distilled from a one-step teacher model and at least one multi-step teacher model.

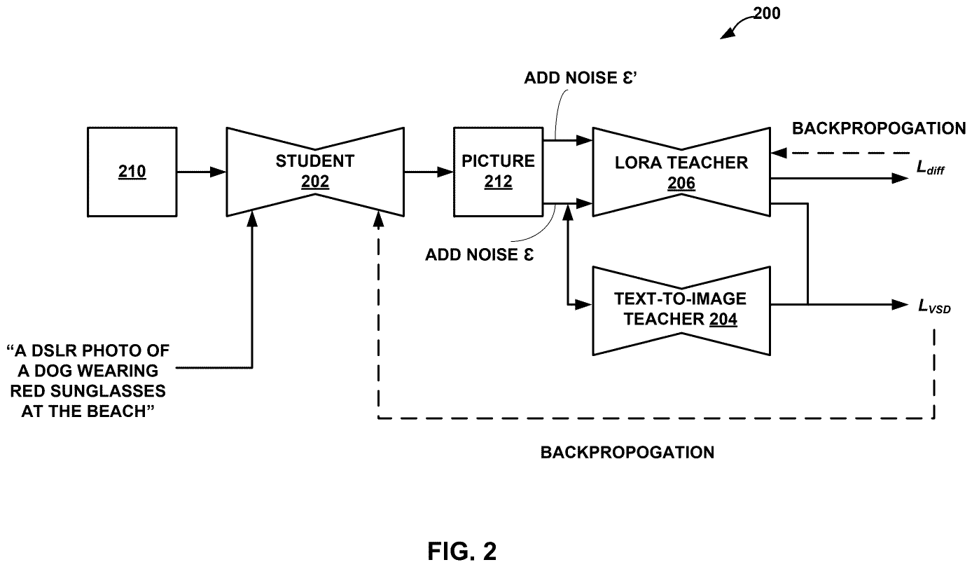

FIG. 2 is a flow diagram illustrating an example distillation technique. A system 200, which may include processing circuitry and memory, such as processing circuitry 110 and memor(ies) 132 of FIG. 1, may train a one-step text-to-image student model 202 from a pretrained multi-step text-to-image teacher 204. System 200 may use a Low-Rank Adaptation (LoRA) teacher 206 to bridge the domain gap between the two models (one-step text-to-image student model 202 and multi-step text-to-image teacher 204) for stable training. For example, one-step text-to-image student model 202 may obtain a prompt of “A DSLR photo of a dog wearing red sunglasses at the beach.” One-step text-to-image student model 202 may obtain noise 210. One-step text-to-image student model 202 may generate an output picture (e.g., image) 212 responsive to the prompt. As such, output picture 212 may resemble a DSLR photo of a dog wearing red sunglasses at the beach. System 200 may add noise to random timesteps of output picture 212. System 200 may send output picture 212 with the added noise to the two teachers, LoRA teacher 206 and multi-step text-to-image teacher 204. The added noise may be the same or different for each teacher. System 200 may compute a variational score distillation (VSD) loss, L_{VSD}, based on the difference between two teacher model outputs, LoRA teacher 206 and multi-step text-to-image teacher 204. A VSD loss is a type of loss used in diffusion model distillation that is used to minimize a KL (Kullback-Leibler) divergence between a distribution of two data sets (e.g., diffused generated data and diffused real data). System 200 may update LoRA teacher 206 using a score matching loss, L_{diff}.

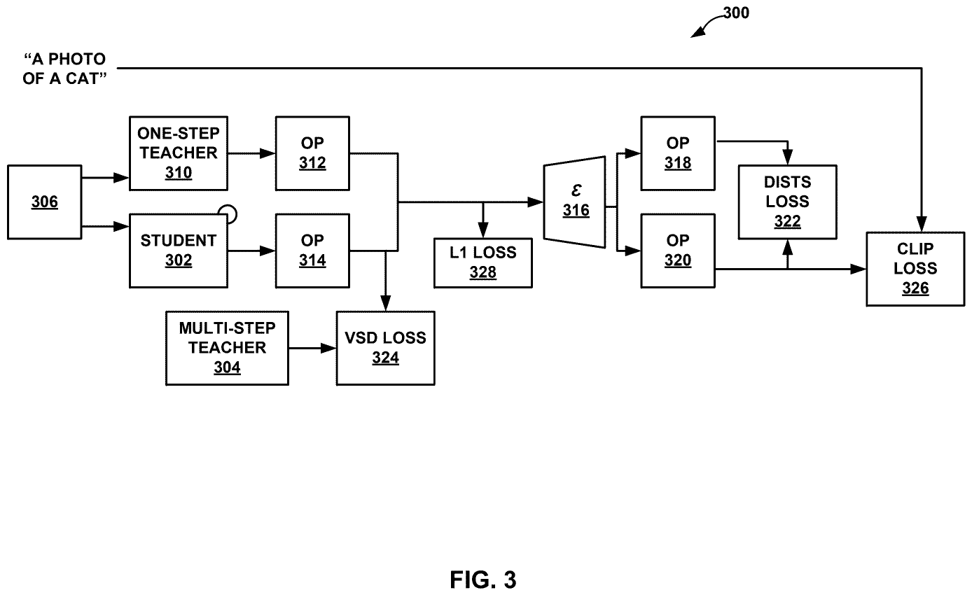

FIG. 3 is a flow diagram illustrating yet another example distillation technique according to one or more aspects of this disclosure. System 300, which may include processing circuitry and memory, such as processing circuitry 110 and memor(ies) 132 of FIG. 1, may employ a one-step model as an additional teacher (e.g., one-step teacher model 310) for better guidance. As such, system 300 may use dual-space output matching: L1 (latent space) and deep image structure and texture similarity (DISTS) (image space). For student model 302's loss terms, system 300 may use the output matching losses (L1 loss 320 and DISTS loss 322) based on one-step teacher model 310. An L1 loss is a loss function that measures an average absolute difference between predicted and actual values. For example, an L1 loss may be indicative of distance metrics from 2 tensors and cause an AI and/or ML model to generate an image similar to synthetic images. A DISTS loss is an image quality assessment metric that may evaluate the perceptual similarity between a reference image and a distorted image. DISTS loss may be indicative of a level of structural distortions (e.g., from noise) and texture resampling.

For VSD loss 324, system 300 may utilize multi-step teacher(s) (e.g., frozen and LoRA training), such as multi-step teacher model 304. For a Contrastive Language-Image Pretraining (CLIP) loss 326, system 300 may enforce text-image alignment. A CLIP loss is a loss function used to train image and text encoders to map similar image-text pairs into close proximity in a shared embedding space. The CLIP loss function attempts to maximizing the similarity between matching image and text and minimizing the similarity between non-matching image and text. Thus, a CLIP loss is an indication of an alignment between a generated image and the prompt. For example, if the prompt is “A photo of a cat” and the image is of a cat, the CLIP loss is likely to be relatively small, while it the image is of a dog, the CLIP loss is likely to be larger.

In some examples, during training and to avoid memory leakage, system 300 may enable a gradient in only one of the steps that student model 302 runs. In some examples, the timestep is chosen randomly among n steps.

In some examples, after training the final model is achieved by merging weights of the trained student model (e.g., a trained version of student model 302) with one-step teacher model 310. In some examples, the system 300 may merge weights of the trained student model with one-step teacher model 310 in accordance with the following the formula:

θ_{merged}=λθ_{A}+(1−λ)θ_{B}

For example, student model 302 may obtain a prompt of “A photo of a cat.” Student model 302 may obtain noise 306. Student model 302 may generate an output picture (e.g., image) (OP) 314 responsive to the prompt. As such, output picture 314 may resemble a photo of a cat. One-step teacher model 310 may also obtain the prompt of “A photo of a cat.” One-step teacher model 310 may also obtain noise 306. One-step teacher model 310 may generate an output picture (e.g., image) (OP) 312 responsive to the prompt. As such, output picture 312 may resemble a photo of a cat. System 300 may use the output picture 314 and an output of multi-step teacher model 304 to determine VSD loss 324.

System 300 may use output picture 312 and output picture 314 to determine L1 loss 328. System 300 may add noise ε 316 to output picture 312 to generate output picture (OP) 318. System 300 may also add noise ε 316 to output picture 314 to generate output picture (OP) 320. System 300 may determine DISTS loss 322 based on output picture 318 and output picture 320. System 300 may determine a CLIP loss based on output picture 320 and the prompt, e.g., “A photo of a cat.”

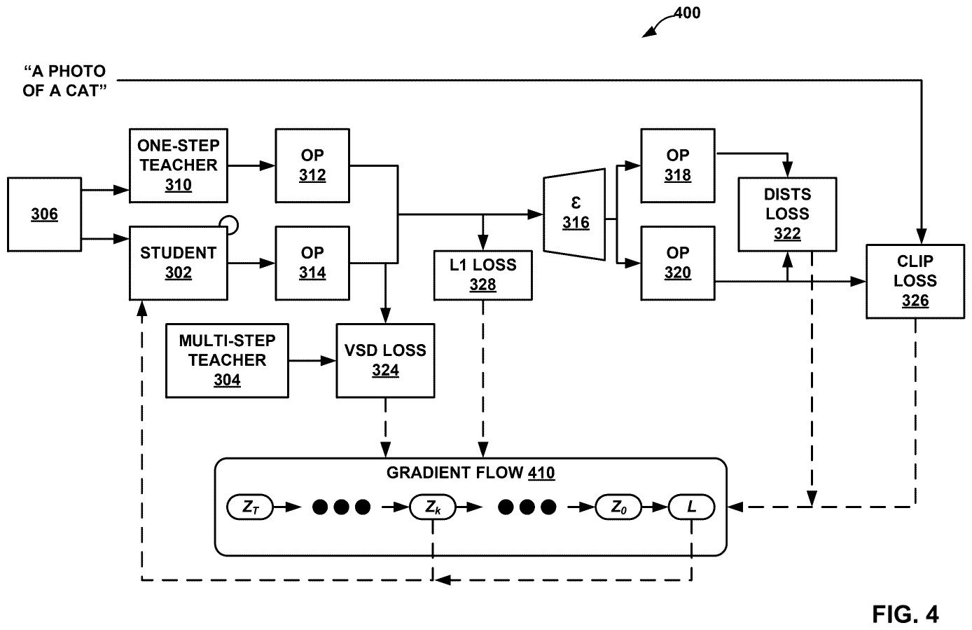

FIG. 4 is a flow diagram illustrating an example gradient flow of the distillation technique of FIG. 3 according to one or more aspects of this disclosure. As such, the example of FIG. 4 is similar to the example of FIG. 3, with an added gradient flow 410. A gradient may be a vector that represents a direction of steepest increase of a function that includes a plurality of inputs. System 400 may be similar to system 300, and like system 300, may train student model 302 using at least four loss functions, namely VSD loss 324, L1 loss 328, DISTS loss 322 and CLIP loss 326. Accumulating all the gradients may take a lot of memory. As such, system 400 may avoid such accumulation. For example, system 400 may select one step (e.g., n) of the steps that student model 302 runs at random. This step may correspond to gradient Zₖ in gradient flow 410. The other shown gradients (Z_{T} and Z₀) and any other gradients not shown may not be used for this particular prompt. During another training run with a different prompt, system 400 may again select one step of the steps that student model 302 runs which may be different than step n. In such a case, an appropriate corresponding gradient may be used. In the example of FIG. 4, the solid lines may represent a forward pass, while the dashed lines may represent a backward pass.

In some examples, system 400 may initialize student model 302 from Stable Diffusion (SD) Turbo. In some examples, one-step teacher model 310 is an SD Turbo one-step teacher model. In some examples, multi-step teacher model 304 is a SD v.2.1 multi-step teacher model.

In some examples, system 400 may use a Tiny Variational Autoencoder (TinyVAE) to decode images during training instead of a Variational Autoencoder (VAE) to reduce the memory usage.

In some examples, the training datasets include DiffusionDB and/or PD12M, which are publicly available datasets. For example, system 400 may use the training datasets DiffusionDB and/or PD12M to train student model 302. In some examples, the training datasets may include both DiffusionDB and PD12M. In some examples, the training length includes about 50,000 training iterations (e.g., around 1 day on one A100 40 GB GPU). In some examples, after training, system 400 may fuse the trained student model's weights with the original weights (e.g., SD Turbo). For example, system 400 may fuse the trained student model's weights with the original weights linearly with, for example, a ratio of 0.5.

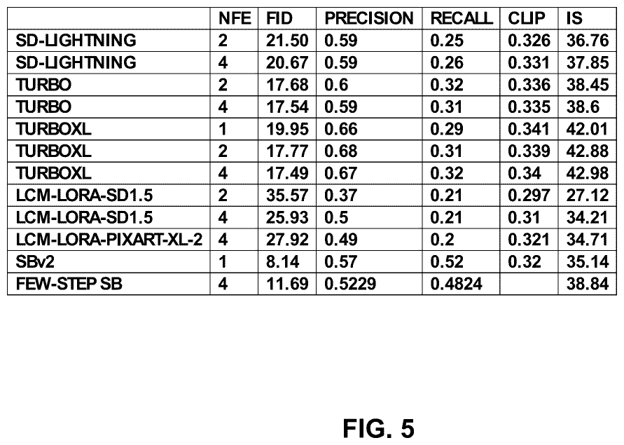

FIG. 5 is a chart illustrating example scores of different models, including the few-step model of this disclosure. The few-step model of this disclosure appears in the chart as Few-step SB. Despite being distilled from a stronger teacher model, a one-step model cannot generate as aesthetically beautiful human images with correct anatomy when compared to the few-step version. The model of this disclosure achieved the best scores compared to all the public few-step models. Despite potentially generating more beautiful images (qualitatively), the model of this disclosure does not surpass the 1-step SwiftBrush (SBv2) in quantitative scores.

In the example of FIG. 5, the NFE column represents a number of NFEs run per the model listed in the rows. For example, 1 in the NFE column for SBv2 indicates that 1 step was run for SBv2 (which is a one-step model, SwiftBrush v. 2). The FID column represents a Frechet Inception Distance metric. FID takes into account the aesthetics of an image and diversity. A smaller FID score is better than a larger FID score. While the FID for SBv2 is better than the Few-step SB model, but utility of the SBv2 model is limited. Precision is a measure of the accuracy of the generated image in relation to the prompt. Recall is a measure of how well a model can generate all the images relevant to the prompt. CLIP is a measure of alignment between generated image and prompt. IS (Inception Score) is a quantitative metric used to evaluate the quality of images.

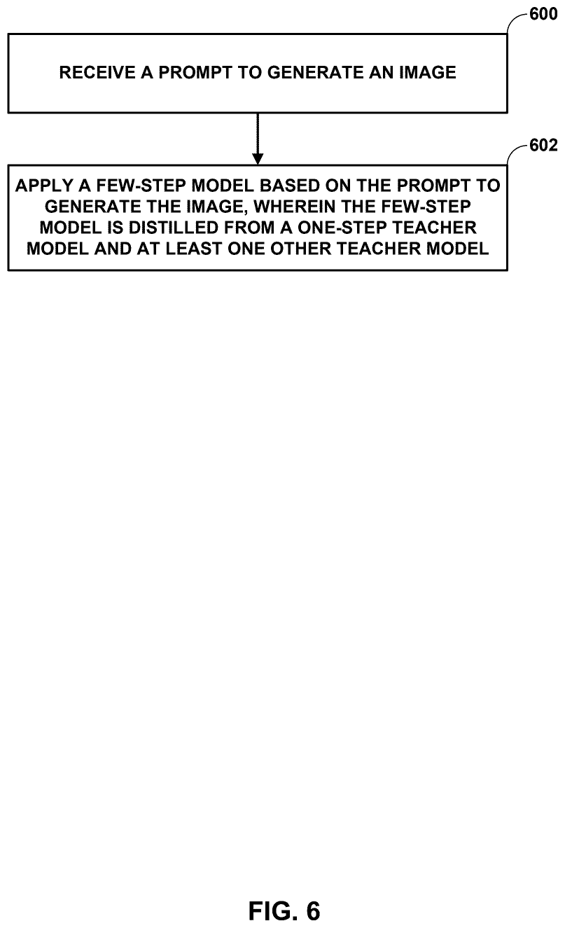

FIG. 6 is a flow diagram illustrating example few-step text-to-image model technique according to one or more aspects of this disclosure. The techniques of FIG. 6 are described with respect to device 100, but may be practiced by any device capable of doing so.

Device 100 may receive a prompt to generate an image (600). For example, a user input a request to generate an image. The request may be in the form of typed text via input device 130, a spoken request via microphone 138, a request obtained via wireless interface 140, a photograph, or the like, or any combination thereof. In some examples, the request or prompt may include a description of the image to be generated, such as “A DSLR photo of a dog wearing red sunglasses on the beach” or “A photo of a cat.”

Device 100 may apply a few-step model based on the prompt to generate the image, wherein the few-step model is distilled from a one-step teacher model and at least one other teacher model (602). For example, device 100 may apply few-step model 120 responsive to the request to generate subject image(s) 114. Few-step model 120 may be distilled from one-step teacher model 310 (e.g., which may be a SwiftBrush model) and multi-step teacher model 304.

In some examples, the prompt is textual and the few-step model is a few-step text-to-image model. In some examples, the one-step teacher model is a SwiftBrush model. In some examples, the at least one other teacher model includes a multi-step teacher model.

In some examples, the at least one other teacher model includes a low-rank adaptation (LoRA) teacher model. In some examples, the few-step model is configured to perform between 1 and 6 number of function evaluations (NFEs), inclusive, to generate the image. In some examples, the few-step model is trained using a variational score distillation (VSD) loss, an L1 loss, a deep image structure and texture similarity (DISTS) loss, and a Contrastive Language-Image Pretraining (CLIP) loss. In some examples, the few-step model is trained using a low-rank adaptation (LoRA) loss.

In some examples, the few-model is distilled based on a gradient applied for one randomly selected step of a plurality of steps of the few-step model. In some examples, the weights of the few-step model include fused weights. In some examples, device 100 is configured to generate the few-step model.

Although one or more of FIG. 1-4 and 6 may illustrate systems, apparatuses, and/or methods according to the teachings of the disclosure, the disclosure is not limited to these illustrated systems, apparatuses, and/or methods. One or more functions or components of any of FIG. 1-4 and/or 6 as illustrated or described herein may be combined with one or more other portions of another of FIG. 1-4 and/or 6. Accordingly, no single implementation described herein should be construed as limiting and implementations of the disclosure may be suitably combined without departing form the teachings of the disclosure. As an example, one or more operations described with reference to FIG. 1-4 and 6 may be optional, may be performed at least partially concurrently, and/or may be performed in a different order than shown or described.

This disclosure include the following non-limiting clauses.

Clause 1A. A device for image generation, the device comprising: one or more memories; and one or more processors coupled to the one or more memories, the one or more processors configured to: receive an input to generate an image; and apply a few-step model to generate the image, wherein the few-step model is distilled from a one-step teacher model and at least one other teacher model.

Clause 2A. The device of claim 1A, wherein the input is textual and the few-step model is a few-step text-to-image model.

Clause 3A. The device of any of clauses 1A-2A, wherein the one-step teacher model is a SwiftBrush model.

Clause 4A. The device of any of claims 1A-3A, wherein the at least one other teacher model comprises a multi-step teacher model.

Clause 5A. The device of any of claims 1A-4A, wherein the at least one other teacher model comprises a low-rank adaptation (LoRA) teacher model.

Clause 6A. The device of any of claims 1A-5A, wherein the few-step model is configured to perform between 1 and 6 number of function evaluations (NFEs) as part of generating the image.

Clause 7A. The device of any of claims 1A-6A, wherein the few-step model is trained using a variational score distillation (VSD) loss, an L1 loss, a deep image structure and texture similarity (DISTS) loss, a Contrastive Language-Image Pretraining (CLIP) loss, and a low-rank adaptation (LoRA) loss.

Clause 8A. The device of any of claims 1A-7A, wherein weights of the few-step model comprise fused weights.

Clause 9A. A method of generating an image, the method comprising: receiving an input to generate an image; and applying a few-step model to generate the image, wherein the few-step model is distilled from a one-step teacher model and at least one other teacher model.

Clause 10A. The method of claim 9A, wherein the input is textual and the few-step model is a few-step text-to-image model.

Clause 11A. The method of any of clauses 9A-10A, wherein the one-step teacher model is a SwiftBrush model.

Clause 12A. The method of any of claims 9A-11A, wherein the at least one other teacher model comprises a multi-step teacher model.

Clause 13A. The method of any of claims 9A-12A, wherein the at least one other teacher model comprises a low-rank adaptation (LoRA) teacher model.

Clause 14A. The method of any of claims 9A-13A, wherein generating the image comprises performing, by the few-step model, between 1 and 6 number of function evaluations (NFEs) as part of generating the image.

Clause 15A. The method of any of claims 9A-14A, wherein the few-step model is trained using a variational score distillation (VSD) loss, an L1 loss, a deep image structure and texture similarity (DISTS) loss, a Contrastive Language-Image Pretraining (CLIP) loss, and a low-rank adaptation (LoRA) loss.

Clause 16A. The method of any of claims 9A-15A, wherein weights of the few-step model comprise fused weights.

Clause 17A. A device configured to generate the few-step model described in any of claims 1A-8A.

Clause 18A. A method of generating the few-step model described in any of claims 9A-16A.

Clause 19A. Non-transitory computer-readable media storing instructions, which when executed by one or more processors, cause the one or more processors to perform the method of any of claims 9A-16A or 18A.

Clause 20A. A device comprising at least one means for performing the method of any of claims 9A-16A or 18A.

Clause 1B. A device for image generation, the device comprising: one or more memories; and one or more processors coupled to the one or more memories, the one or more processors configured to: receive a prompt to generate an image; and apply a few-step model based on the prompt to generate the image, wherein the few-step model is distilled from a one-step teacher model and at least one other teacher model.

Clause 2B. The device of clause 1B, wherein the prompt is textual and the few-step model is a few-step text-to-image model.

Clause 3B. The device of any of clauses 1B-2B, wherein the one-step teacher model is a SwiftBrush model.

Clause 4B. The device of any of clauses 1B-3B, wherein the at least one other teacher model comprises a multi-step teacher model.

Clause 5B. The device of any of clauses 1B-4B, wherein the at least one other teacher model comprises a low-rank adaptation (LoRA) teacher model.

Clause 6B. The device of any of clauses 1B-5B, wherein the few-step model is configured to perform between 1 and 6 number of function evaluations (NFEs), inclusive, to generate the image.

Clause 7B. The device of any of clauses 1B-6B, wherein the few-step model is trained using a variational score distillation (VSD) loss, an L1 loss, a deep image structure and texture similarity (DISTS) loss, and a Contrastive Language-Image Pretraining (CLIP) loss.

Clause 8B. The device of clause 7B, wherein the few-step model is trained using a low-rank adaptation (LoRA) loss.

Clause 9B. The device of any of clauses 7B or 8B, wherein the few-step model is distilled based on a gradient applied for one randomly selected step of a plurality of steps of the few-step model.

Clause 10B. The device of any of clauses 1B-9B, wherein weights of the few-step model comprise fused weights.

Clause 11B. The device of any of clauses 1B-10B, wherein the one or more processors are configured to generate the few-step model.

Clause 12B. A method of generating an image, the method comprising: receiving a prompt to generate the image; and applying a few-step model based on the prompt to generate the image, wherein the few-step model is distilled from a one-step teacher model and at least one other teacher model.

Clause 13B. The method of clause 12B, wherein the prompt is textual and the few-step model is a few-step text-to-image model.

Clause 14B. The method of any of clauses 12B-13B, wherein the one-step teacher model is a SwiftBrush model.

Clause 15B. The method of any of clauses 12B-14B, wherein the at least one other teacher model comprises a multi-step teacher model.

Clause 16B. The method of any of clauses 12B-15B, wherein the at least one other teacher model comprises a low-rank adaptation (LoRA) teacher model.

Clause 17B. The method of any of clauses 12B-16B, wherein generating the image comprises performing, by the few-step model, between 1 and 6 number of function evaluations (NFEs) to generate the image.

Clause 18B. The method of any of clauses 12B-17B, wherein the few-step model is trained using a variational score distillation (VSD) loss, an L1 loss, a deep image structure and texture similarity (DISTS) loss, and a Contrastive Language-Image Pretraining (CLIP) loss.

Clause 19B. The method of clause 18B, wherein the few-step model is trained using a low-rank adaptation (LoRA) loss.

Clause 20B. Non-transitory computer-readable media storing instructions, which when executed by one or more processors, cause the one or more processors to: receive a prompt to generate an image; and apply a few-step model based on the prompt to generate the image, wherein the few-step model is distilled from a one-step teacher model and at least one other teacher model.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for image generation, the device comprising:
one or more memories; and
one or more processors coupled to the one or more memories, the one or more processors configured to:
receive a prompt to generate an image; and
apply a few-step model based on the prompt to generate the image, wherein the few-step model is distilled from a one-step teacher model and at least one other teacher model.

2. The device of claim 1, wherein the prompt is textual and the few-step model is a few-step text-to-image model.

3. The device of claim 1, wherein the one-step teacher model is a SwiftBrush model.

4. The device of claim 1, wherein the at least one other teacher model comprises a multi-step teacher model.

5. The device of claim 1, wherein the at least one other teacher model comprises a low-rank adaptation (LoRA) teacher model.

6. The device of claim 1, wherein the few-step model is configured to perform between 1 and 6 number of function evaluations (NFEs), inclusive, to generate the image.

7. The device of claim 1, wherein the few-step model is trained using a variational score distillation (VSD) loss, an L1 loss, a deep image structure and texture similarity (DISTS) loss, and a Contrastive Language-Image Pretraining (CLIP) loss.

8. The device of claim 7, wherein the few-step model is trained using a low-rank adaptation (LoRA) loss.

9. The device of claim 7, wherein the few-step model is distilled based on a gradient applied for one randomly selected step of a plurality of steps of the few-step model.

10. The device of claim 1, wherein weights of the few-step model comprise fused weights.

11. The device of claim 1, wherein the one or more processors are configured to generate the few-step model.

12. A method of generating an image, the method comprising:
receiving a prompt to generate the image; and
applying a few-step model based on the prompt to generate the image, wherein the few-step model is distilled from a one-step teacher model and at least one other teacher model.

13. The method of claim 12, wherein the prompt is textual and the few-step model is a few-step text-to-image model.

14. The method of claim 12, wherein the one-step teacher model is a SwiftBrush model.

15. The method of claim 12, wherein the at least one other teacher model comprises a multi-step teacher model.

16. The method of claim 12, wherein the at least one other teacher model comprises a low-rank adaptation (LoRA) teacher model.

17. The method of claim 12, wherein generating the image comprises performing, by the few-step model, between 1 and 6 number of function evaluations (NFEs) to generate the image.

18. The method of claim 12, wherein the few-step model is trained using a variational score distillation (VSD) loss, an L1 loss, a deep image structure and texture similarity (DISTS) loss, and a Contrastive Language-Image Pretraining (CLIP) loss.

19. The method of claim 18, wherein the few-step model is trained using a low-rank adaptation (LoRA) loss.

20. Non-transitory computer-readable media storing instructions, which when executed by one or more processors, cause the one or more processors to:
receive a prompt to generate an image; and
apply a few-step model based on the prompt to generate the image, wherein the few-step model is distilled from a one-step teacher model and at least one other teacher model.
